(19) United States
(12) Patent Application Publication
(10) Pub. No.: US 2007/0047560 A1
(43) Pub. Date: Mar. 1, 2007

(54) Wireless bridge with beam-switching antenna arrays and method thereof

(75) Inventors: Ting-Yi Tsai, Taipei City (TW); I-Ru Liu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Accton Technology Corporation

(21) Appl. No.: 11/216,902

(22) Filed: Aug. 31, 2005

(51) Int. Cl. H04L 12/28

(52) U.S. Cl. 370/401

(57) ABSTRACT

A wireless bridge for communicating with another wireless bridge. The wireless bridge comprises a plurality of phased-array antennas, an antenna selector and a transceiver. The phased-array antennas each forms a beam and transmits/receives a signal to/from the other wireless bridge, and the beams are overlapped in angles. The antenna selector is connected to the phased-array antennas for selecting one as a main antenna according to the plurality of received signals. The received signal strength indicator (RSSI) of the signal received by the main antenna is the largest than that received by the other phased-array antennas. Then the transceiver makes transmission/reception via the main antenna.

### BACKGROUND OF THE INVENTION

1. Field of the Invention

The invention relates in general to the wireless device, and more particularly to the wireless bridge with beam-switching antenna arrays.

2. Description of the Related Art

Wireless network such as WLAN 802.11 standard is getting more and more popular in these days because it provides air interface to a plurality of wireless client devices and it is easy to implement without cables. The service range of a base station of WLAN is about 100 M. If a larger service range is desired, such as a link between two buildings, two wireless bridges can be respectively disposed at each building and each connected to the LAN of the corresponding building such that the two LANs are connected via the wireless bridges.

FIG. 1 is a diagram of a conventional point-to-point wireless bridge. The wireless bridge 100 includes a single phased-array antenna 110, a transmission/reception switch (T/R switch) 120, a power amplifier (PA) 130, a low-noise amplifier (LNA) 140, a transceiver 150, a base-band processor/media access control (BBP/MAC) 160, and an indicator 170. The single phased-array antenna 110 forms a narrow beam so it is suitable for point-to-point transmission.

But it is not easy to align the wireless bridge 100 with the other because the beam of the single phased-array antenna 110 is very narrow. Thus the wireless bridge 100 is conventionally equipped with the indicator 170 showing whether the two wireless bridges are aligned. Even if the wireless bridges are aligned, the direction of the beams of the antennas are likely affected by the winds, vibrations, time-varying multipaths and etc., and then the disadvantage is that it should be manually aligned again, which is very inconvenient and time-wasting.

### SUMMARY OF THE INVENTION

It is therefore an object of the invention to provide a point-to-point wireless bridge to automatically align with the other.

The invention achieves the above-identified objects by providing a wireless bridge for communicating with another wireless bridge. The wireless bridge comprises a plurality of phased-array antennas, an antenna selector and a transceiver. The phased-array antennas each forms a beam, and receives/transmits a signal from/to the other wireless bridge, and the beams are overlapped in angles. The antenna selector is connected to the phased-array antennas for selecting one as a main antenna according to the plurality of signals received. The received signal strength indicator (RSSI) of the signal received by the main antenna is the largest than that received by the other phased-array antennas. Then the transceiver makes transmission/reception via the main antenna.

The invention achieves the above the other objects by providing a method for beam-switching used in the wireless bridge. The method includes the following steps. (a) The method first wide-scans each of the phased-array antennas to get the RSSIs of the signal transmitted from the other wireless bridge. (b) Next, at least two phased-array antennas having the larger RSSIs are selected as a candidate antenna set. (c) Next, the phased-array antenna having the largest RSSI is selected as a main antenna for transmission/reception. (d) If a scheduled event occurs, the main antenna is re-selected by scanning the phased-array antennas in the candidate antenna set to get RSSIs thereof. (d) If a weak-signal event occurs, the main antenna is re-selected by repeating steps (a)-(c).

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of a conventional point-to-point wireless bridge.

FIG. 2 is a block diagram of a point-to-point wireless bridge according to the preferred embodiment of the invention.

FIG. 3 is a flowchart of the method of beam-switching.

FIG. 4A is a diagram of the first type of the beams generated by the phased-array antennas.

FIG. 4B is a diagram of the second type of the beams generated by the phased-array antennas.

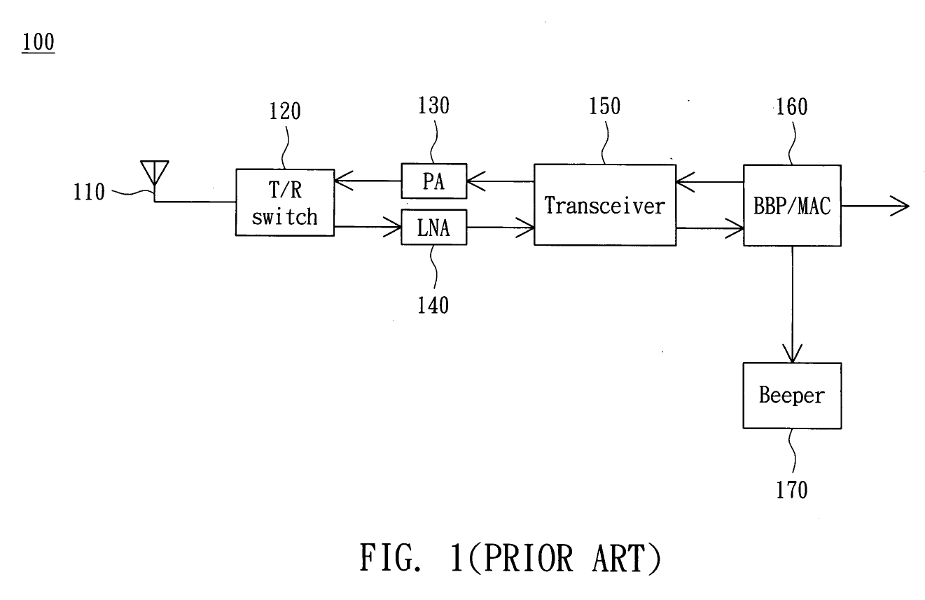

### DETAILED DESCRIPTION OF THE INVENTION

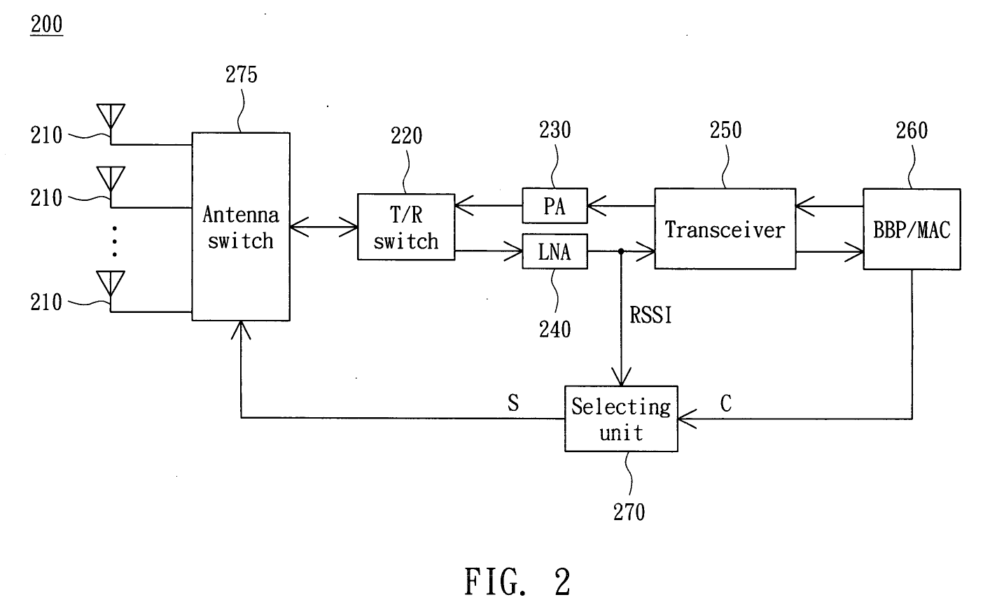

FIG. 2 is a block diagram of a point-to-point wireless bridge according to the preferred embodiment of the invention. The wireless bridge 200 communicates with the other wireless bridge (not shown) so as to connect two LANs thereof. The wireless bridge 200 includes a plurality of phased-array antennas 210, a transmission/reception (T/R) switch 220, a power amplifier (PA) 230, a low noise amplifier (LNA) 240, a transceiver 250, a base-band processor/media access control (BBP/MAC) 260 and a antenna selector. The antenna selector includes a selecting unit 270 and an antenna switch 275. The wireless bridge 200 utilizes the phased-array antennas because their beams are more focused and suitable for point-to-point transmission.

The phased-array antennas 210 each forms a beam so as to receive/transmit the signals from/to the other wireless bridge. The antenna selector is connected to the phased-array antennas 210 and selects one therefrom as a main antenna.

The transmission/reception switch 220 determines whether transmission or reception is executed. While transmission, the transmission/reception switch 220 outputs the signal, which is processed in turn by the base-band processor/media access control (BBP/MAC) 260, the transceiver 250, the power amplifier 230, via the main antenna. While reception, the transmission/reception switch 220 receives signals from the main antenna and outputs to the power amplifier 230.

The selecting unit 270 selects one as the main antenna from the phased-array antennas 210 in response to the RSSI or the control signal C from the base-band processor/media access control (BBP/MAC) 260 and makes the antenna switch 275 to switch to the main antenna. The control signal C is generated according to a scheduled event, which occurs at every predetermined time intervals. In the embodiment, the RSSI is extracted from the output end of the LNA 240. The covered area of the beams of the phased-array antennas 210 of the wireless bridge 200 is wide enough such that the alignment with the other wireless bridge is easier. The antenna selector can be implemented by FPGA (Field-programmable Gate Array) so as to flexibly alter the criterion of beam-switching.

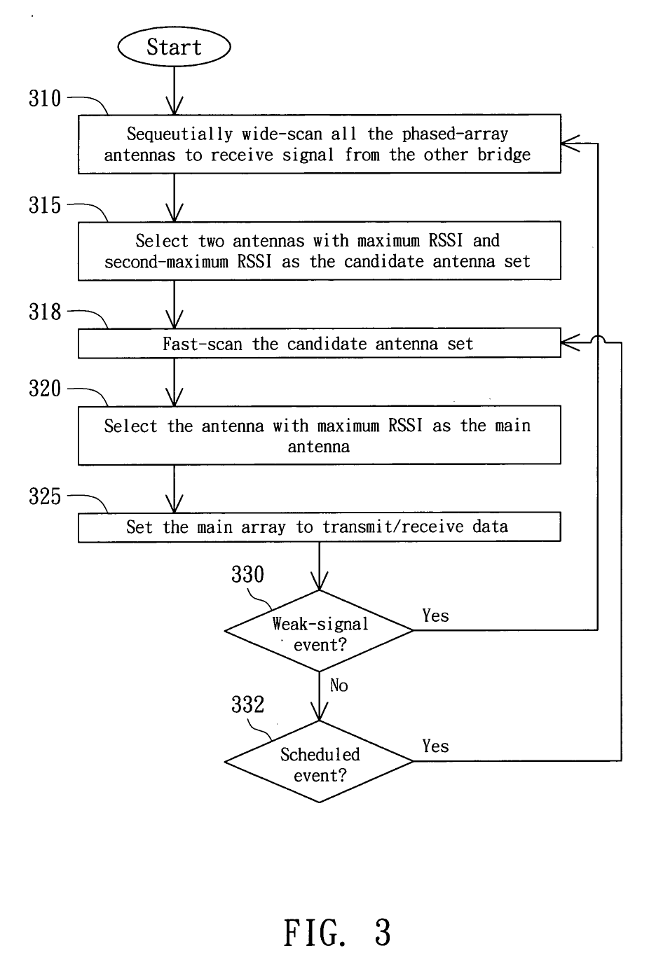

FIG. 3 is a flowchart of the method of beam-switching. First, in step 310, the wide-scan is performed to scan all the phased-array antennas 210 and examine their RSSIs of the received signals from the other wireless bridge of same SSID. The RSSIs can be extracted from the output end of the low noise amplifier 240 or from the base-band processor/media access control (BBP/MAC) 260.

Next, in step 315, the two phased-array antennas 210 having the first maximum and the second maximum RSSIs are selected as the candidate antenna set. It should be noticed that the number of the phased-array antennas in the candidate antenna set is not limited to two and is feasible if three is chosen.

Next, the fast-scan is performed in step 318 to scan the RSSIs of the received signals of phased-array antennas 210 in the candidate antenna set. Then in step 320, the phased-array antenna 210 with the maximum RSSI is selected as the main antenna. Then the main antenna is used to transmit/receive data, as shown in step 325. The wireless bridge 200 is thus linked up and in alignment with the other wireless bridge via the main antenna.

While a weak-signal event occurs in step 330, steps 310-320 are re-processed to re-select a new main antenna, else step 332 is performed. The weak-signal event is generated if the RSSI, the signal quality, the link quality, or the quality of service (QoS) is low.

While a scheduled event occurs in step 332, the fast-scan is re-performed in step 318 to scan the RSSIs of the received signals of phased-array antennas 210 in the candidate antenna set. Then a new main antenna that has the maximum RSSI is re-selected from the phased-array antennas 210 in the candidate antenna set, as shown in step 325. The scheduled event is generated at predetermined time intervals, for example. The time it takes to perform the fast-scan is shorter than that of the wide-scan because the number of the phased-array antennas 210 in the candidate antenna set is fewer.

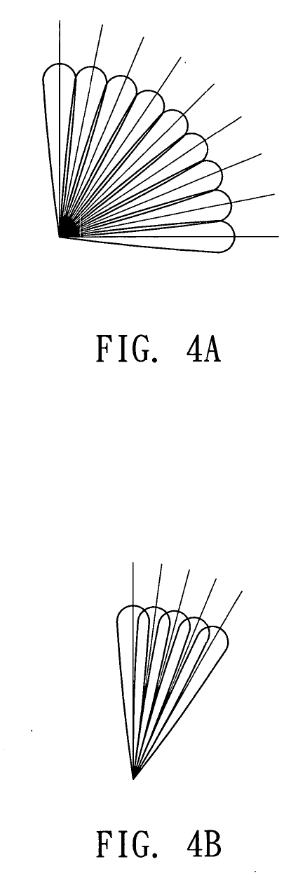

FIG. 4A is a diagram of the first type of the beams generated by the phased-array antennas. The number of the phased-array antennas 210 is 7, and the total coverage thereof is 90 degree. Therefore, the beam width is 90/7=12.857 degree. Practically the total coverage is seldom greater than 120 degrees and the individual beam width is seldom less than 5 degrees to get rid of the clumsiness of array system; the number of the phased-array antenna is greater or much greater than 3 to get the contrast between the field of views of wide-scan and fast-can.

FIG. 4B is a diagram of the second type of the beams generated by the phased-array antennas. The number of the phased-array antennas 210 is 5, and the total coverage thereof is 30 degree, such that the beam width is 30/5=6 degree. Compared to the first type of the beams, although the total coverage is narrower, the second type of the beams can align more accurately with the other wireless bridge because of the narrow beam width.

The wireless bridge with the beam-switching antenna and the method for the same can automatically align with the other wireless bridge without manual control and therefore it is very easy and convenient to get the best signal quality.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless bridge, used for communicating with an other wireless bridge, the wireless bridge comprising:
a plurality of phased-array antennas, each forming a beam and receiving a signal from the other wireless bridge, wherein the beams are overlapped;
an antenna selector connected to the phased-array antennas, for selecting one as a main antenna according to the plurality of received signals; and
a transceiver for transmission/reception via the main antenna;
wherein a received signal strength indicator (RSSI) of the signal received by the main antenna is the largest than that received by the other phased-array antennas.

2. The wireless bridge according to claim 1, further comprising a media access control (MAC) for communicating with the transceiver.

3. The wireless bridge according to claim 1, wherein the antenna selector re-selects the main antenna in response to a weak-signal event generated if the RSSI, a signal quality, a link quality, or a quality of service (QoS) is low.

4. The wireless bridge according to claim 1, wherein the antenna selector re-selects the main antenna in response to a scheduled event generated at every predetermined time intervals.

5. A method for beam-switching used in a wireless bridge including a plurality of phased-array antennas, the method comprising:
(a) wide-scanning each of the phased-array antennas to get the RSSIs of the signal received from the other wireless bridge;
(b) selecting at least two phased-array antennas having the larger RSSIs as a candidate antenna set;
(c) selecting a phased-array antenna having the largest RSSI as a main antenna for transmission/reception;
(d) re-selecting the main antenna by scanning the phased-array antennas in the candidate antenna set to get RSSIs thereof and if a scheduled event occurs; and
(e) re-selecting the main antenna by repeating steps (a)-(c) if a weak-signal event occurs.

6. The method according claim 5, wherein the antenna the weak-signal event occurs if the RSSI, a signal quality, a link quality, or a quality of service (QoS) is low.

7. The method according to claim 5, wherein the scheduled event occurs at every predetermined time intervals.
